(19) United States
(12) Patent Application Publication
(10) Pub. No.: US 2005/0060824 A1
(43) Pub. Date: Mar. 24, 2005

(54) Dryer duct and register brush

(76) Inventor: Stephen Hillenbrand, Concord, CA (US)

Correspondence Address: STEPHEN HILLENBRAND, 937 AUTUMN OAK, CONCORD, CA, 94521, US

(21) Appl. No.: 10/666,013

(22) Filed: Sep. 22, 2003

(51) Int. Cl. A46B 3/18; B08B 9/00

(52) U.S. Cl. 15/104.2; 15/206

(57) ABSTRACT

Dryer duct and register brush with an elongate handle, a shaft consisting of a pair of semi rigid twisted metal wires and a plurality of bristles intertwined within the twisted wire shaft in a perpendicular orientation. A protective soft plastic cap is fixedly attached to and covering the tip of the wire shaft. The bristles are radially arranged about the shaft so that the bristles form a brush member approximately four inches in diameter and four inches long. The bristles are made of semi rigid nylon or the like. The bristles are equally spaced so that there are approximately one hundred and twenty bristles per linear inch. The shaft is approximately forty three inches long and has a diameter of approximately two hundred and twenty five thousandths of an inch.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of cleaning brushes and more specifically to a dryer duct and register brush.

Cleaning brushes of many types are well known. One type of known brush construction includes the process of twisting a pair of metal wires and trapping bristles in a perpendicular fashion within the metal twists so that the bristles are radially formed about the axial shaft.

One other inventor has tried to address the problem of dryer duct cleaning. John Alonso in his U.S. Pat. No. 5,819,354 describes a duct cleaning apparatus a combination of stiff bristles and flexible bristles are attached to a flexible pole like shaft. The bristles described are made of wire. My experiments that wire bristles can damage thin walled metal or plastic tubular ducts. Additionally, the shaft, although flexible, can not be bent to more severe angles that are sometimes needed when cleaning ducts that bend at acute angles. Finally, the Alonso patent does not disclose a method of grabbing and removing lint and other debris from a clogged duct.

### BRIEF SUMMARY OF THE INVENTION

The primary object of the invention is to provide a brush that can remove lint and hairs caught in drier ducts and heating register vents.

Another object of the invention is to provide a brush that can easily fit the contours the inside diameter of a standard dryer vent duct.

Another object of the invention is to provide a brush that improves dryer and heating efficiency.

Another object of the invention is to provide a brush whose bristles can grasp clogged lint inside a duct and help pull it out.

A further object of the invention is to provide a brush reduces the possibility of fire within ducts.

Yet another object of the invention is to provide a brush that helps reduce power usage to dryers.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed dryer duct and register brush comprising: an elongate handle, a shaft consisting of a pair of twisted metal wires, a plurality of bristles intertwined with said twisted wire shaft in a perpendicular orientation, a protective soft plastic cap fixedly attached to and covering the tip of said wire shaft, said shaft being fixedly and longitudinally attached to said handle, said bristles being radially arranged about said shaft so that said bristles form a brush member approximately four inches in diameter and four inches long, said bristles being made of nylon or the like and each having a diameter of approximately thirty two thousandths of an inch, said bristles being equally spaced so that there are approximately one hundred and twenty bristles per linear inch, said shaft being approximately forty three inches long, and said shaft having a diameter of approximately two hundred and twenty five thousandths of an inch.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

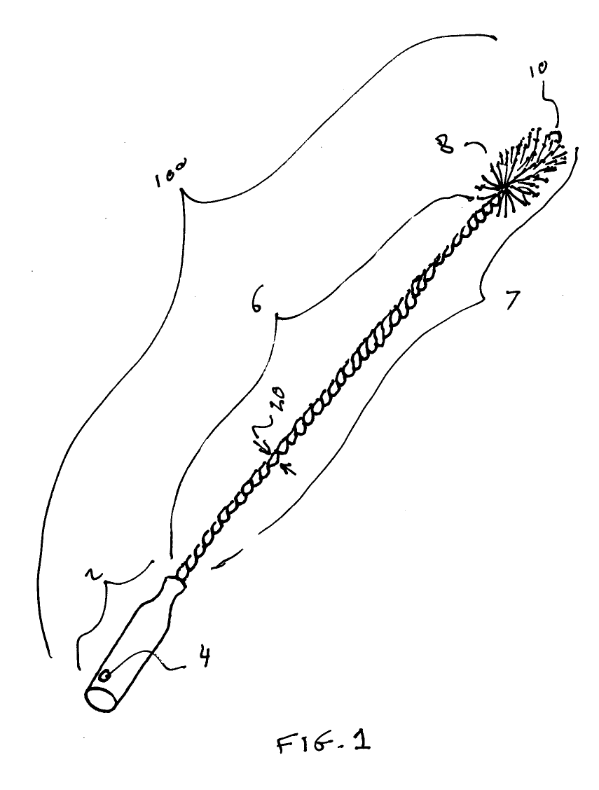

FIG. 2 is a partial exploded view of the tip portion of the invention

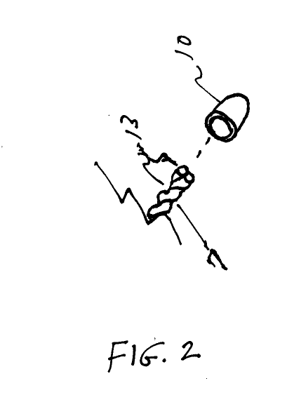

FIG. 3 is a partial side section view of the bristle portion inside a standard flexible duct

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

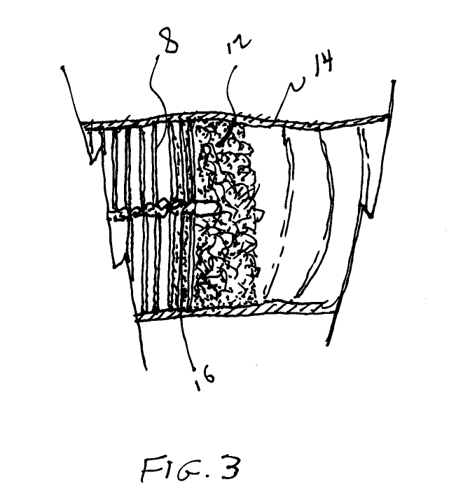

Referring now to Figure one we see a side perspective view of the present invention 100. The invention consists of an elongate handle portion 2 fixedly connected to a twisted pair of metal wires forming a shaft 7 terminating in a bristle portion 8 and a soft plastic shaft tip 10. Although this general method of making brushes is known, for example, a standard bottle cleaning brush, my experiments have shown that it requires a design whose wire shaft diameter and length, bristle material, bristle length and bristle density are specifically suited to the act of cleaning standard flexible four inch diameter ducts such as those found at the back of a standard clothes dryer. The ducts are typically made of thin walled PVC plastic or thin walled metallic coated material supported by an internal spiral wire form. The duct cleaning device 100 of the present invention has a long shaft length 7 of approximately forty three inches so that it can penetrate deeply into a standard flexible four inch diameter duct. The wire diameter 20 is approximately two hundred and twenty five thousandths of an inch which is thick enough to not buckle when being pressed into a duct and against a clump of lint or the like, yet thin enough to be able to bend to the various curvatures of standard flexible ducts. The bristles of the invention 100 are intertwined with the shaft 7 so that the bristles are fixed radially about the shaft 7 forming a brush member that is approximately four inches in diameter and four inches long. The bristles are preferably made of nylon and have a preferred diameter of thirty two thousandths of an inch which is stiff enough to engage the compacted lint in a duct but not so stiff as to damage the thin duct walls. Wire bristles would not be ideal in this duct cleaning application. The bristle concentration results in approximately one hundred and twenty bristles per linear inch. This density provides maximum cleaning ability and allows the user to twist and rotate the bristles so that they penetrate a clump of lodged lint allowing the user to effectively pull the lint out. This action is shown in FIG. 3 where bristles 8 have been rotated by the user in a similar way that a person twists a fork into a plate full of spaghetti. The twisting action allows the bristles 8 to penetrate 16 the lodged clump of lint 12 or the like. The relatively dense and intertwined quality of the lint found in duct shafts is such that when the bristles 8 partially penetrate 16 the clump 12, the user may use the tool 100 to pull back the attached bristles 8 and the entire clump of lint 12 will be pulled out of the duct 14. The shaft length between the top of the handle 2 and the bottom of the brush member 8 is thirty nine inches. The handle 2 is preferably constructed of wood because of its rigid, non slip, non conducting properties, however, a textured plastic handle will also perform adequately. The handle preferably includes an aperture 4 so that the tool 100 may be hung on a peg or the like. The sharp tip 13 if the twisted wire shaft 7 is protected by a soft plastic cap 10 made of elastomeric vinyl or the like. This configuration protects the inner duct walls from being damaged. The diameter 20 of shaft 7 is such that the shaft 7 can be bent completely on itself at a convenient mid point thereby halving the overall length of the brush 100 so that the cleaning brush 100 may be shipped and stored in a compact configuration. The brush 100 also effective in cleaning the metal duct area just below standard heating or air conditioning registers by removing the register, loosening dirt and debris from the duct with the brush 100 and then vacuuming out the resulting loose material. The relatively long lenth of the shaft 7 allows the user to reach clogged materials that are deep inside a duct.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. Dryer duct and register brush comprising:
an elongate handle;
a shaft consisting of a pair of twisted metal wires;
a plurality of bristles intertwined with said twisted wire shaft in a perpendicular orientation;
a protective soft plastic cap fixedly attached to and covering the tip of said wire shaft;
said shaft being fixedly and longitudinally attached to said handle;
said bristles being radially arranged about said shaft so that said bristles form a brush member approximately four inches in diameter and four inches long;
said bristles being made of nylon or the like and each having a diameter of approximately thirty two thousandths of an inch;
said bristles being equally spaced so that there are approximately one hundred and twenty bristles per linear inch;
said shaft being approximately forty three inches long; and
said shaft having a diameter of approximately two hundred and twenty five thousandths of an inch.

2. Dryer duct and register brush as claimed in claim 1 wherein said shaft can be bent to accommodate twists and turns in standard four inch dryer ducts.

3. Dryer duct and register brush as claimed in claim 1 wherein said shaft can be bent in half for compact storage and shipping.

4. Dryer duct and register brush as claimed in claim 1 wherein said handle is made of non slip wood or plastic.

5. Dryer duct and register brush as claimed in claim 1 wherein said handle includes an aperture so that the present invention can be hung on a peg or the like.
